(19) United States
(12) Patent Application Publication
(10) Pub. No.: US 2008/0185990 A1
(43) Pub. Date: Aug. 7, 2008

(54) Portable power storage and supply module

(76) Inventor: Yu-Che Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,904

(22) Filed: Jan. 31, 2008

(30) Foreign Application Priority Data
Feb. 2, 2007 (TW) 96202067

(51) Int. Cl. H02J 7/02; H02J 7/00

(52) U.S. Cl. 320/103; 320/111

(57) ABSTRACT

A portable power storage and supply module includes a case, a battery module, and at least one USB socket. The case and the battery module are correspondingly provided with a plurality of conducting strips and a plurality of conducting contacts, respectively. A rechargeable battery is received in an inner space of the battery module and has a voltage output. The USB socket is arranged on the case at a predetermined position to electrically connect to the voltage output of the rechargeable battery, so that voltage output from the rechargeable battery is supplied to the USB socket.

### FIELD OF THE INVENTION

The present invention relates to a power storage and supply device, and more particularly to a portable power storage and supply module that can be carried by a user for supplying power to various types of portable electronic devices.

### BACKGROUND OF THE INVENTION

Due to their compactness and convenience for use, portable electronic devices have gradually replaced other conventional electronic apparatus to meet most people's requirement in the busy commercial society. With the portable personal multimedia electronic devices and many related products thereof, people may learn new things, release emotional pressure, or enjoy audio and visual (AV) signals with special effects at any place and at any time to thereby enhance personal working efficiency and upgrade living quality. The currently available cell phones, personal digital assistants (PDAs), portable computers, stock information receiving units, etc. all are typical portable electronic devices.

However, most users of these portable electronic devices have a common problem of obtaining a convenient power source to readily supply power to these portable electronic devices. Currently, the portable electronic devices are mainly powered by a battery pack supplied along with and mounted on the portable electronic devices, such as a lithium-ion or a nickel-cadmium battery mounted on a cell phone. In addition to the battery mounted on the portable electronic device, the user would usually carry about with him one or more spare batteries for replacing the one on the portable electronic device when necessary. These spare batteries would no doubt bring inconveniences to the user in storing and carrying them. Since different types of portable electronic devices use different working power specifications, batteries for one type of portable electronic device may not be usable to supply working power to other types of portable electronic devices. Therefore, the user has to carry about with him one or more spare batteries for each different type of the portable electronic devices. It is troublesome and uneconomical to do so. Moreover, the spare batteries tend to become inactive when they are not used over a long time. Therefore, even if these portable electronic devices are supplied with an exclusive charging device, they still have to rely on the public power facilities to be charged.

### SUMMARY OF THE INVENTION

A primary object of the present invention is to provide a portable power storage and supply module, which allows a user to supply electric power from only one power supply device to various types of portable electronic devices.

Another object of the present invention is to provide a portable power storage and supply module, with which various portable electronic devices may be charged at any place and at any time without relying on public power facilities.

To fulfill the above objects, the present invention provides a portable power storage and supply module. The portable power storage and supply module includes a case, a battery module, and at least one USB socket. The case and the battery module are correspondingly provided with a plurality of conducting strips and a plurality of conducting contacts, respectively. A rechargeable battery is received in an inner space of the battery module and has a voltage output. The USB socket is arranged on the case at a predetermined position to electrically connect to the voltage output of the rechargeable battery, so that voltage output from the rechargeable battery is supplied to the USB socket.

The present invention may be carried about with a user to supply electric power to different types of portable electronic devices, and may obtain required power from a car or an airplane during driving or flying without relying on the public power facilities.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view of a portable power storage and supply module according to a first embodiment of the present invention;

FIG. 2 is an assembled bottom view of the portable power storage and supply module according to the present invention;

FIG. 3 is an assembled perspective view of the portable power storage and supply module according to the present invention;

FIG. 4 is an assembled side view of the portable power storage and supply module according to the present invention;

FIG. 5 shows the use of the portable power storage and supply module according to the present invention;

FIG. 6 is an assembled top view of the portable power storage and supply module according to the present invention;

FIG. 7 is a side plan view of a portable power storage and supply module according to a second embodiment of the present invention; and

FIG. 8 is a side plan view of a portable power storage and supply module according to a third embodiment of the present invention.

### DETAILED DESCRIPTION OF THE PREFERRED EMBODIMENTS

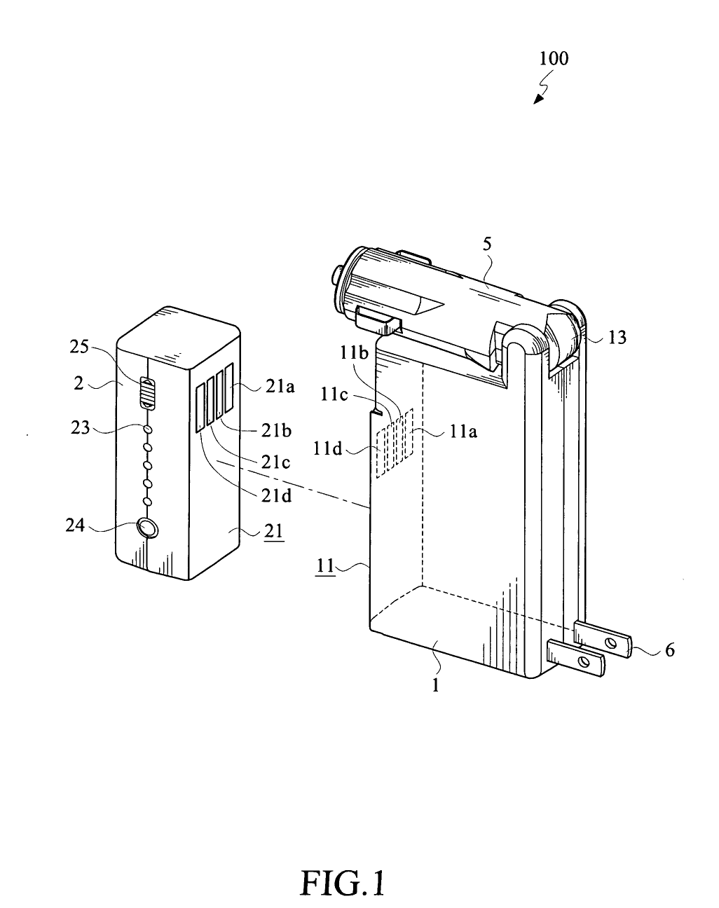

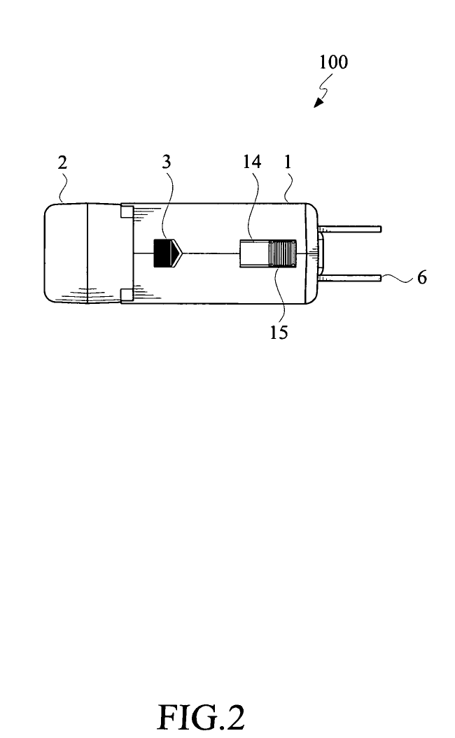

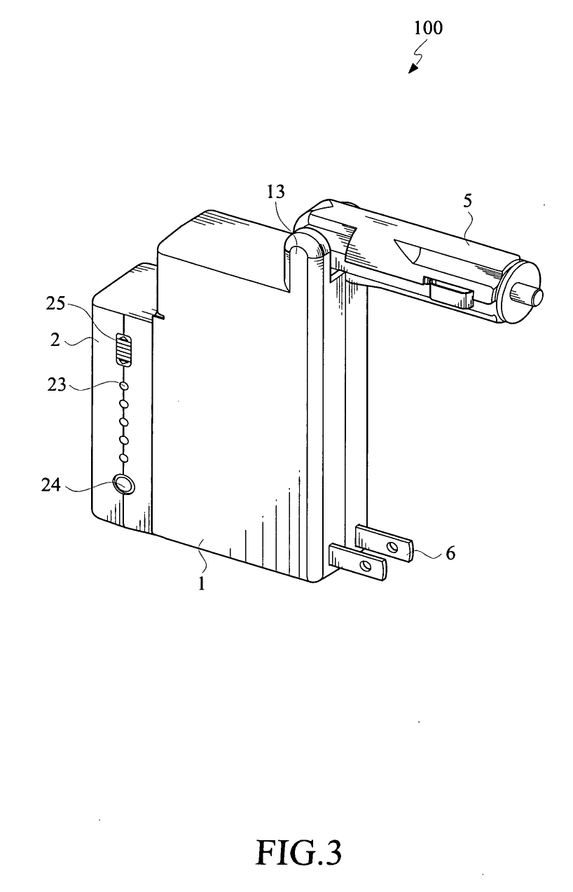

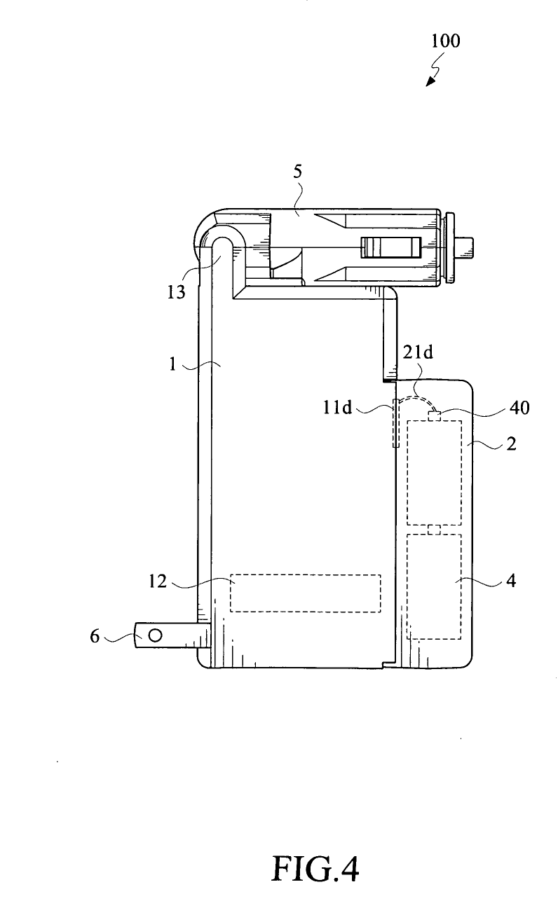

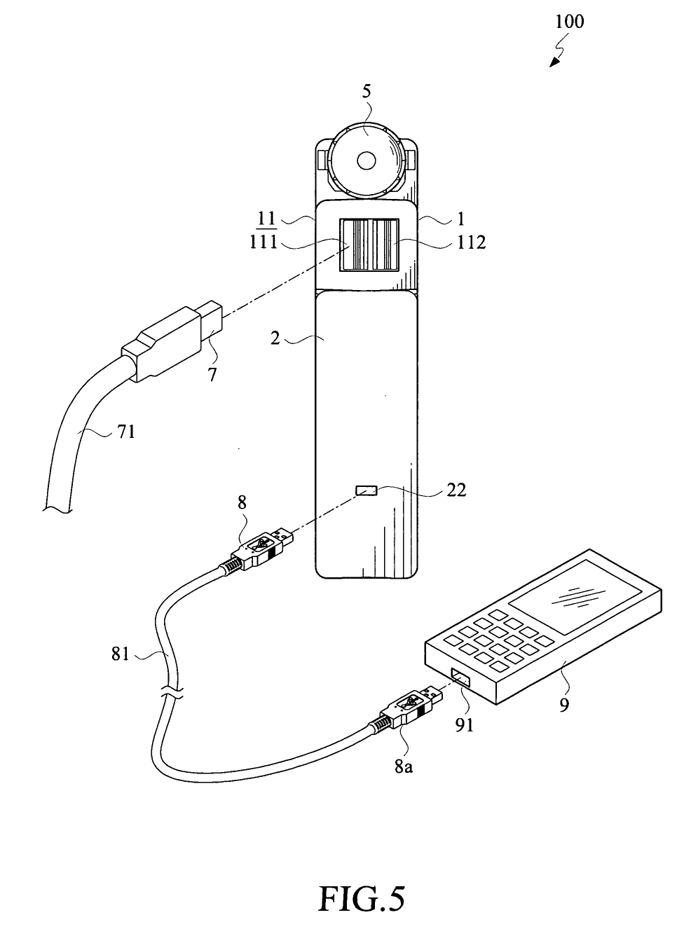

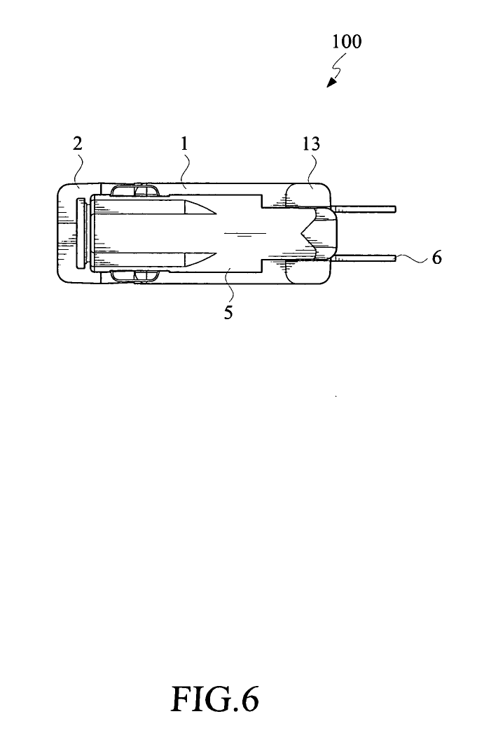

Please refer to FIGS. 1 to 6. FIG. 1 is an exploded perspective view of a portable power storage and supply module according to a first embodiment of the present invention. FIGS. 2, 3 and 4 respectively show an assembled bottom view, a perspective view and a side view of the portable power storage and supply module. FIG. 5 shows the use of the portable power storage and supply module, and FIG. 6 shows a top view of the portable power storage and supply module.

A portable power storage and supply module 100 according to a first embodiment of the present invention includes a case 1, a battery module 2, a fastening device 3, at least one rechargeable battery 4, a cigarette lighter plug 5, and an alternating current (AC) plug 6.

The case 1 includes a battery connecting side 11, and four conducting strips 11a, 11b, 11c, 11d are arranged. The battery module 2 includes a connecting side 21, and four conducting contacts 21a, 21b, 21c, 21d are arranged corresponding to the four conducting strips 11a, 11b, 11c, 11d on the case 1. The fastening device 3 detachably secures the battery module 2 to the battery connecting side 11 of the case 1, such that the conducting contacts 21a, 21b, 21c, 21d at the connecting side of the battery module 2 are in contact with the corresponding conducting strips 11a, 11b, 11c, 11d on the case 1.

The rechargeable battery 4 is received in an inner space defined in the battery module 2, and includes a voltage output 40. The case 1 is provided at an upper area on the battery connecting side 11 with two USB (Universal Serial Bus) sockets 111, 112. When the battery module 2 is secured to the battery connecting side 11 of the case 1, the two USB sockets 111, 112 are electrically connected to the voltage output 40 of the rechargeable battery 4 via the conducting contacts 21a, 21b, 21c, 21d on the battery module 2 and the conducting strips 11a, 11b, 11c, 11d on the case 1, so that voltage output by the rechargeable battery 4 is supplied to the two USB sockets 111, 112. A USB plug 7 may be plugged into either of the two USB sockets 111, 112 to connect an electronic device to the rechargeable battery 4 via a cable 71.

The battery module 2 is provided at one side opposite to the connecting side 21 with a mini USB socket 22, which is connected to the voltage output 40 of the rechargeable battery 4 to output power stored in the rechargeable battery 4. A mini USB plug 8 provided at a first end of a cable 81 may be plugged into the mini USB socket 22, and another mini USB plug 8a provided at a second end of the cable 81 may be plugged into a USB socket 91 provided on any portable electronic device 9. Therefore, the portable power storage and supply module 100 of the present invention may be used to supply power to various types of portable electronic devices.

The case 1 is internally provided with a circuit board 12, and externally provided on a top with a pivot hinge 13, via which the cigarette lighter plug 5 is connected to the case 1, so that the cigarette lighter plug 5 is turnable about the pivot hinge 13 relative to the case 1 by a predetermined angle for conveniently plugging into a cigarette lighter socket on a car or a corresponding jack on an airplane to obtain direct current (DC) power. The DC power obtained via the cigarette lighter plug 5 is converted via circuits on the circuit board 12 to supply an output voltage to the USB sockets 111, 112 on the case 1 and the mini USB socket 22 on the battery module 2, and to simultaneously charge the rechargeable battery 4, provided the battery module 2 is secured to the case 1.

The AC plug 6 is provided on the case 1 near a lower end on one side thereof opposite to the battery connecting side 11 for plugging into an AC power supply. The AC power supply obtained via the AC plug 6 is converted by the circuits on the circuit board 12 to supply an output voltage to the USB sockets 111, 112 on the case 1 and the mini USB socket 22 on the battery module 2, and to simultaneously charge the rechargeable battery 4, provided the battery module 2 is secured to the case 1.

The case 1 is provided on a bottom surface at a predetermined position with a slide way 14 and a slidable button 15. The slidable button 15 is located in the slide way 14 and connected to the AC plug 6. A user may push the slidable button 15 forward along the slide way 14 to extend the AC plug 6 from the case 1 for plugging into a general AC receptacle to obtain an AC power supply. When the rechargeable battery 4 has been fully charged, the user may retract the AC plug 6 into the case 1 simply by pushing the slidable button 15 backward along the slide way 14.

The battery module 2 is provided at predetermined positions with a set of indicating lamps 23 and a push button 24. The set of indicating lamps 23 is electrically connected to the rechargeable battery 4, and the push button 24 may be pushed for the set of indicating lamps 23 to indicate the power available from the rechargeable battery 4.

The battery module 2 may also be provided at a predetermined position with a switch 25 for controlling the rechargeable battery 4 to supply power or cut off power to the voltage output 40.

When the battery module 2 is separated from the case 1 and the rechargeable battery 4 received in the battery module 2 has sufficient power stored therein, the user may use the battery module 2 to supply power to a portable electronic device via the mini USB socket 22 alone. Alternatively, the user may plug the cigarette lighter plug 2 on the case 1 into a cigarette lighter socket on a car or a corresponding jack of an airplane to obtain DC power supply, or plug the AC plug 6 on the case 1 into a general AC receptacle. And, the external power obtained via the cigarette lighter plug 2 or the AC plug 6 may be output to a portable electronic device via either of the two USB sockets 111, 112 provided on the case 1.

When the battery module 2 is secured to the case 1 and the rechargeable battery 4 received in the inner space of the battery module 2 is sufficiently charged, the rechargeable battery 4 is able to output a voltage to the USB sockets 111, 112 and the mini USB socket 22 at the same time.

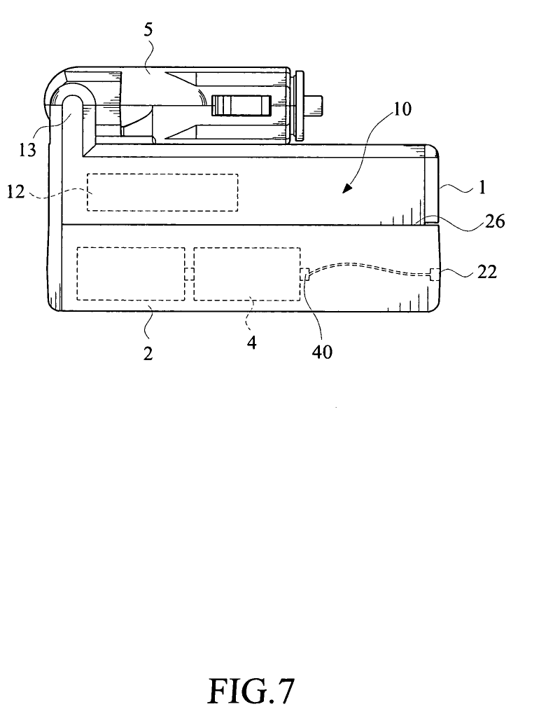

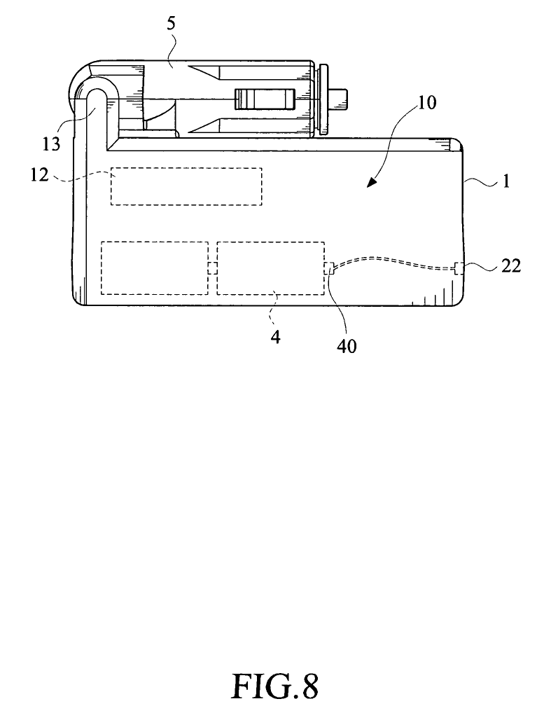

FIG. 7 is a side plan view of a portable power storage and supply module according to a second embodiment of the present invention. The second embodiment is generally structurally similar to the first embodiment, except for a battery module 2 that is inseparably connected to one side of the case 1 through a welding line 26 formed by way of radio-frequency welding. The voltage output 40 of the rechargeable battery 4 in the battery module 2 may be electrically connected to the USB socket 22 on the battery module 2 and the circuit board 12 in the case 1. Of course, the rechargeable battery 4 and the circuit board 12 may be otherwise directly mounted in an inner space 10 of an integrally constructed case 1, as shown in FIG. 8 that is a side plan view of a portable power storage and supply module according to a third embodiment of the present invention.

Although the present invention has been described with reference to the preferred embodiments thereof, as well as the best mode for carrying out the present invention, it is apparent to those skilled in the art that a variety of modifications and changes may be made without departing from the scope of the present invention which is intended to be defined by the appended claims.

What is claimed is:

1. A portable power storage and supply module, comprising:
a case having a battery connecting side, and a plurality of conducting strips are arranged thereon;
a battery module having a connecting side, and a plurality of conducting contacts are arranged corresponding to the plurality of conducting strips on the case; the battery module being secured at the connecting side to the battery connecting side of the case, such that each of the conducting contacts provided on the connecting side of the battery module is in contact with one of the conducting strips correspondingly provided on the battery connecting side of the case;
at least one rechargeable battery being received in an inner space defined in the battery module and including a voltage output; and
at least a first USB socket being arranged at a predetermined position on the case, and electrically connectable to the voltage output of the rechargeable battery via the conducting contacts on the battery module and the conducting strips on the case.

2. The portable power storage and supply module as claimed in claim 1, wherein the battery module is further provided at a predetermined position with a second USB socket, which is electrically connected to the voltage output of the rechargeable battery.

3. The portable power storage and supply module as claimed in claim 1, wherein the case is provided at a predetermined position with a cigarette lighter plug.

4. The portable power storage and supply module as claimed in claim 1, wherein the case is provided at a predetermined position with an AC plug.

5. The portable power storage and supply module as claimed in claim 4, wherein the case is provided at a predetermined position with a slide way and a slidable button slidably located in the slide way and connected to the AC plug, whereby a user may extend and retract the AC plug from and into the case by pushing the slidable button forward and rearward along the slide way, respectively.

6. The portable power storage and supply module as claimed in claim 1, wherein the battery module is provided at a predetermined position with a set of indicating lamps and a push button; the set of indicating lamps being electrically connected to the voltage output of the rechargeable battery, and the push button being used to control the set of indicating lamps to indicate power available from the rechargeable battery.

7. The portable power storage and supply module as claimed in claim 1, wherein the battery module is detachably secured at the connecting side to the battery connecting side of the case via a fastening device.

8. A portable power storage and supply module, comprising:
a case defining an inner space;
at least one USB socket arranged on the case at a predetermined position; and
a battery module including at least one rechargeable battery received in an inner space defined in the battery module and has a voltage output electrically connected to the USB socket, such that power stored in the rechargeable battery is supplied to the USB socket via the voltage output.

9. The portable power storage and supply module as claimed in claim 8, wherein the case is provided at a predetermined position with a cigarette lighter plug.

10. The portable power storage and supply module as claimed in claim 8, wherein the case is provided at a predetermined position with an AC plug.
